(19) United States
(12) Patent Application Publication
(10) Pub. No.: US 2022/0204133 A1
(43) Pub. Date: Jun. 30, 2022

(54) ELECTRIC WHEEL HUB

(71) Applicant: SOLID YEAR CO., LTD., New Taipei City (TW)

(72) Inventor: Herman HUANG, Taipei City (TW)

(21) Appl. No.: 17/499,321

(22) Filed: Oct. 12, 2021

(30) Foreign Application Priority Data
Dec. 28, 2020 (TW) 109146493

(51) Int. Cl. B62M 7/12; B60B 27/02; B60B 27/04; B60B 27/00; B62J 43/10; H02K 7/08; H02K 11/00; H02K 11/30; H02K 21/22

(52) U.S. Cl. CPC B62M 7/12; B60B 27/023; B60B 27/04; B60B 27/0015; H02K 21/22; H02K 7/085; H02K 11/0094; H02K 11/30; B62J 43/10

(57) ABSTRACT

An electric wheel hub is provided, including: a shell; a motor assembly, including a stator, a rotor and a shaft, the stator and the rotor being received in the shell and relatively rotatable, the rotor being connected and rotatable with the shell, the shaft defining an axial direction and a circumferential direction, the shaft being movable in the axial direction and disposed through the stator, the shaft and the stator being relatively non-rotatable in the circumferential direction; and a battery unit, received in the shell, electrically connected with the motor assembly.

### BACKGROUND OF THE INVENTION

### Field of the Invention

The present invention relates to an electric wheel hub.

### Description of the Prior Art

Bicycles were prevalent in many places. With the changes in lifestyles, the environmental awareness and the concept of physical fitness, bicycles are popularly used in daily lives. With development of technology, electric bicycles have been a booming trend, especially in cities. The electric bicycles can be roughly classified into types with hub motor and mid-mounted motor. The advantages of the type with hub motor are that it is compact and artistic in appearance, that the appearance of the bicycle is concise, that the price is low, that there is relatively lower level of requirement for the bicycle frame, and that there is relatively lower requirement for the chain, so the electric bicycles are popular around the world. TW M580517, TW M580522 and TW 1701176 disclose the like electric bicycles.

However, the above-mentioned wheel hub motor has a complicated structure, many parts and components are interconnected, and it is difficult and time-consuming to dismantle and replace. Therefore, it needs a repairer who knows specific model of the wheel hub motor well to repair and/or replace the parts and components, which is inconvenient.

The present invention is, therefore, arisen to obviate or at least mitigate the above-mentioned disadvantages.

### SUMMARY OF THE INVENTION

The main object of the present invention is to provide an electric wheel hub which can greatly simplify the difficulty of maintenance and/or replacement.

To achieve the above and other objects, an electric wheel hub is provided, including: a shell; a motor assembly, including a stator, a rotor and a shaft, the stator and the rotor being received in the shell and relatively rotatable, the rotor being connected and rotatable with the shell, the shaft defining an axial direction and a circumferential direction, the shaft being movable in the axial direction and disposed through the stator, the shaft and the stator being relatively non-rotatable in the circumferential direction; and a battery unit, received in the shell, electrically connected with the motor assembly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing an application of a preferable embodiment of the present invention;

FIG. 2 is a partial enlarged cross-sectional of FIG. 1;

FIG. 3 is a stereogram of a preferable embodiment of the present invention;

FIG. 4 is a partial breakdown drawing of a preferable embodiment of the present invention;

FIG. 5 is a detailed breakdown drawing of a preferable embodiment of the present invention;

FIG. 6 is a drawing showing a shaft, a frame and two end caps of a preferable embodiment of the present invention;

FIG. 7 is a side view of the shaft and the frame combined according to a preferable embodiment of the present invention; and

FIG. 8 is a drawing showing the shaft and the two end caps combined according to a preferable embodiment of the present invention.

### DETAILED DESCRIPTION OF THE PREFERRED EMBODIMENTS

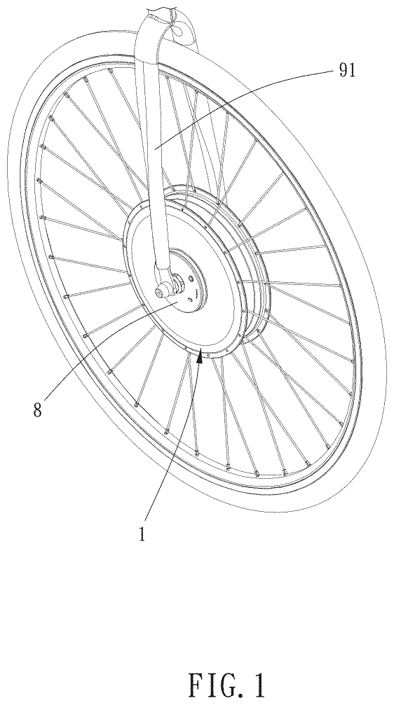

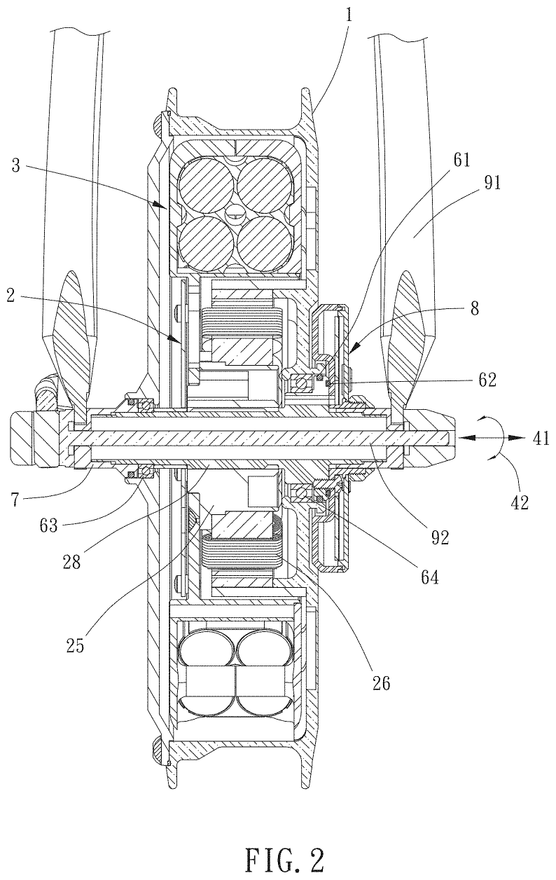

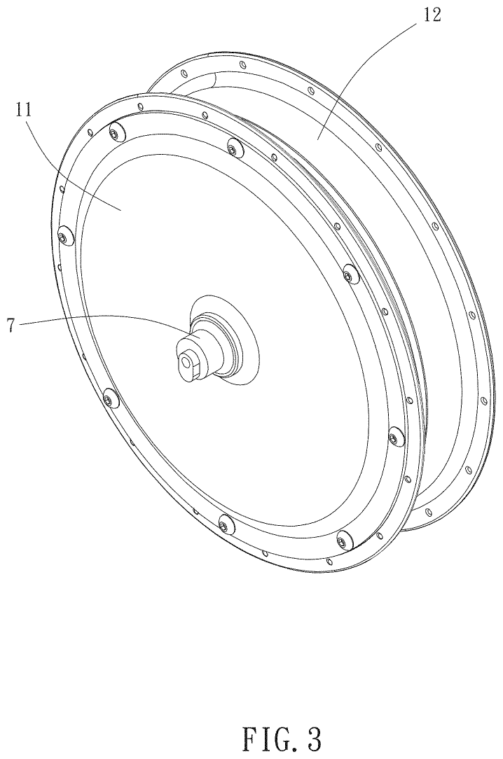

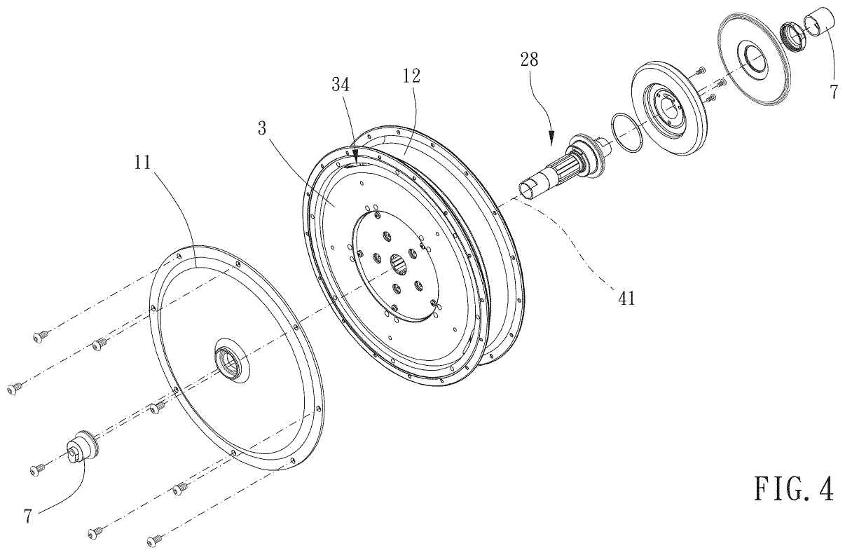

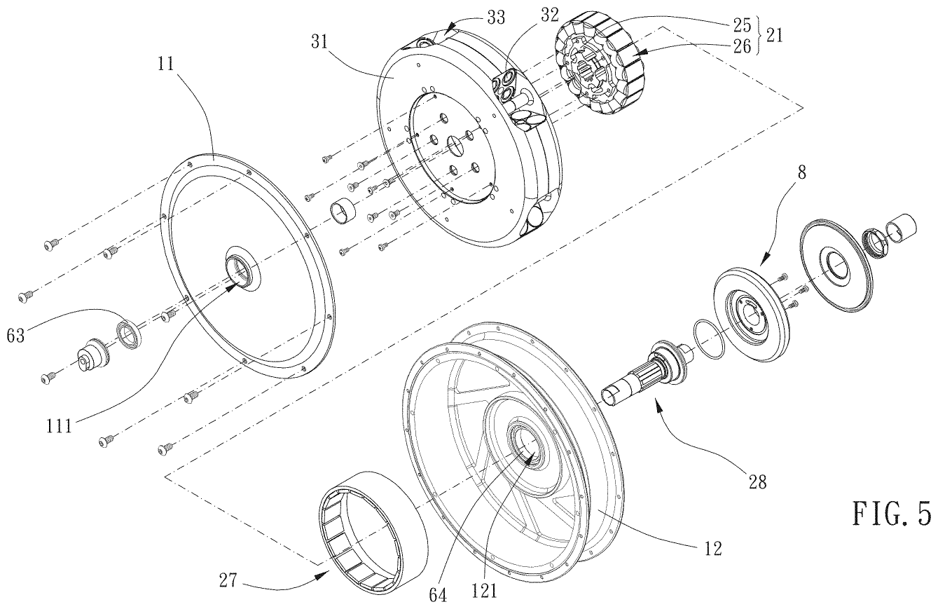

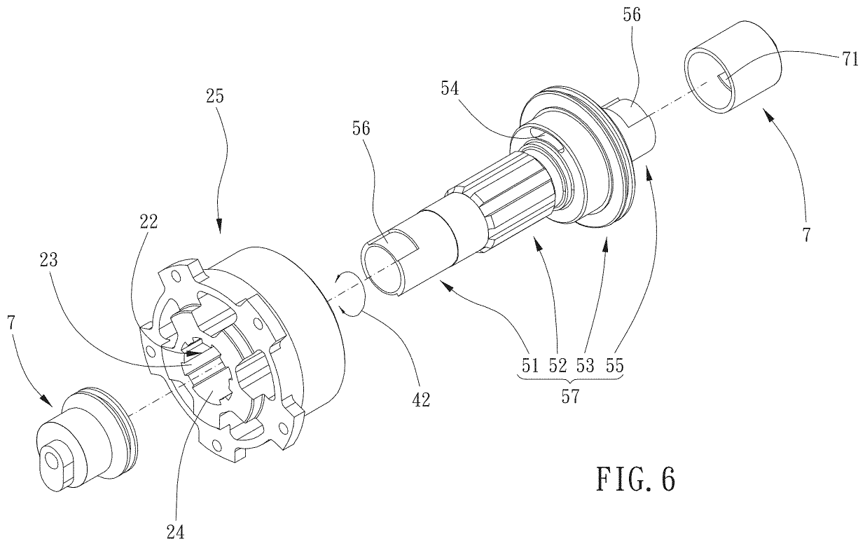

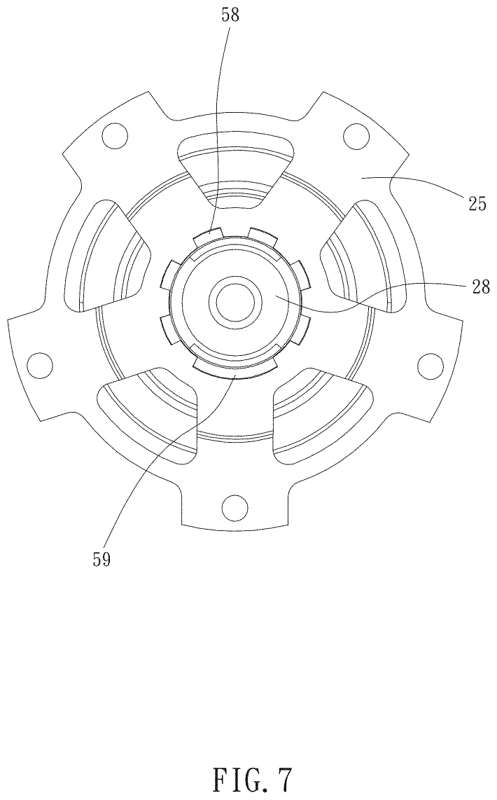

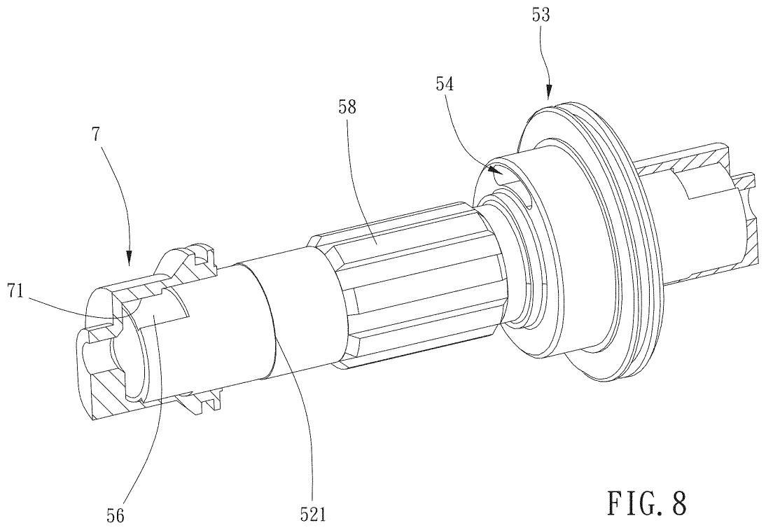

Please refer to FIGS. 1 to 8 for a preferable embodiment of the present invention. An electric wheel hub of the present invention includes a shell 1, a motor assembly 2 and a battery unit 3.

The motor assembly 2 includes a stator 21, a rotor 27 and a shaft 28, the stator 21 and the rotor 27 are received in the shell 1 and relatively rotatable, and the rotor 27 is connected and rotatable with the shell 1. The shaft 28 defines an axial direction 41 and a circumferential direction 42, the shaft 28 is movable in the axial direction 41 and disposed through the stator 21, and the shaft 28 and the stator 21 are relatively non-rotatable in the circumferential direction 42. The battery unit 3 is received in the shell 1 and electrically connected with the motor assembly 2. The shaft 28 is detachably connected with the stator 21 so that the wheel hub can be quickly detached or installed without dismantling parts in the motor assembly 2, which is easy to uninstall/install and lowers the repairing cost.

Specifically, the electric wheel hub further includes a first bearing 63 and a second bearing 64, the shell 1 includes a base 12 and a cover 11, and the cover 11 is detachably covered to the base 12. The cover 11 includes a first through hole 111, the base 12 includes a second through hole 121, the first bearing 63 is received in the first through hole 111, the second bearing 64 is received in the second through hole 121, and the shaft 28 is disposed through the first bearing 63 and the second bearing 64 and protrusive out beyond opposing sides of the shell 1. Since the shaft 28 is detachably connected to the stator 21, the first bearing 63 and the second bearing 64 do not have to be detached as the shaft 28 is removed, which avoids loss of the first bearing 63 and the second bearing 64, and simplifies the detachment process. To replace the first bearing 63 or the second bearing 64, the motor assembly 2 does not have to be detached, which is easy and convenient.

Specifically, the shaft 28 further includes a first end portion 51, a connection portion 52, a flange 53 and a second end portion 55 in sequence. The first end portion 51 is disposed through the first bearing 63 and the cover 11, the second end portion 55 is disposed through the second bearing 64 and the base 12, and the connection portion 52 is connected with the stator 21. An intersection of the connection portion 52 and the first end portion 51 includes a stepped portion 521, the first bearing 63 is abutted against the cover 11 and the stepped portion 521 in the axial direction 41, and the second bearing 64 is abutted between the base 12 and the flange 53 between so as to improve stability of the first bearing 63 and the second bearing 64.

The shaft 28 further includes an axle 57 and a plurality of first engaging portions 58, and the plurality of first engaging portions 58 are separately arranged on the axle 57 in the circumferential direction 42. The axle 57 includes the first end portion 51, the connection portion 52, the flange 53 and the second end portion 55, the connection portion 52 includes the plurality of first engaging portions 58, and the stator 21 includes a perforation 22 and a plurality of second engaging portions 23. The plurality of second engaging portions 23 are separately arranged around the perforation 22 in the circumferential direction 42. The axle 57 is disposed through the perforation 22. The plurality of first engaging portions 58 and the plurality of second engaging portions 23 are engaged with each other so that the shaft 28 is detachable from the stator 21. One of each said first engaging portion 58 and the second engaging portion 23 is a first groove, and the other of each said first engaging portion 58 and the second engaging portion 23 is a first rib. For example, each said first engaging portion 58 is a first rib, and each said second engaging portion 23 is a first groove.

Preferably, the shaft 28 further includes a third engaging portion 59, the stator 21 further includes a fourth engaging portion 24, and the third engaging portion 59 and the fourth engaging portion 24 are engaged with each other. One of the third engaging portion 59 and the fourth engaging portion 24 is a second groove, and the other of the third engaging portion 59 and the fourth engaging portion 24 is a second rib, so that the shaft 28 and the stator 21 can be easily and accurately assembled. The second groove is not identical to the first groove, and the second rib is not identical to the first rib.

The battery unit 3 includes a cartridge 31 and a plurality of batteries 32, and the plurality of batteries 32 are positionally received within the cartridge 31 so that it is easy to install and maintain and is stable. In other embodiments, the battery unit 3 may be provided without the cartridge 31. The cartridge 31 is preferably made of plastic material (such as ABS-PC material) which is of good insulation.

In this embodiment, the cartridge 31 is annular, the cartridge 31 is disposed around the motor assembly 2, and the plurality of batteries 32 are separately disposed around the motor assembly 2. Specifically, the motor assembly 2 is inserted to a central portion of the cartridge 31, and the cartridge 31 is connected with the stator 21 and is not connected with the shell 1, so that the cartridge 31 is non-rotatable for providing good stability of the plurality of batteries 32.

Specifically, the stator 21 includes a frame 25 and a winding coil set 26, the winding coil set 26 is wound around the frame 25, the shaft 28 is disposed through the frame 25, the frame 25 includes the perforation 22, the plurality of second engaging portions 23 and the fourth engaging portion 24, and the cartridge 31 is connected with the frame 25. As a result, to replace the battery unit 3, it needs only to withdraw the shaft 28 and open the cover 11, and the battery unit 3 can be easily replaced without dismantling parts inside the motor assembly 2 and without dismantling the first bearing 63 and the second bearing 64.

Preferably, inner walls of the cartridge 31 and the shell 1 define at least one insertion portion 34 therebetween, and the at least one insertion portion 34 is configured for easy detachment of the cartridge 31 from the shell 1. In this embodiment, the at least one insertion portion includes a plurality of insertion portions 34, an outer circumferential wall of the cartridge 31 includes a plurality of openings 33, the plurality of batteries 32 are partially exposed from the opening 33, and the plurality of openings 33 and the inner wall of the shell 1 form the plurality of the insertion portion 34. The plurality of batteries 32 can be observed from the plurality of openings 33, which helps to evaluate conditions of the plurality of batteries 32.

The electric wheel hub further includes two end caps 7 configured to be respectively connected to two fork arms 91, the two end caps 7 are detachably disposed respectively around opposing ends of the shaft 28, and the shaft 28 is hollow and configured for a spindle 92 to be disposed therethrough. The shaft 28 which is hollow can lower the weight and increase compatibility for the spindle 92. For example, various types of end caps can be used to receive various types of the spindles (having respective diameters of 9 mm, 12 mm and 15 mm, for example).

Preferably, each of the opposing ends of the shaft 28 includes a first positioning portion 56, each of the two end caps 7 includes a second positioning portion 71, and the second positioning portion 71 and the first positioning portion 56 are engaged with each other so as to provide stable and accurate combination of the two end caps 7 and the shaft 28. One of the first positioning portion 56 and the second positioning portion 71 is a projection, and the other of the first positioning portion 56 and the second positioning portion 71 is a recess.

In this embodiment, each said third engaging portion 59 is one said second rib, and each said fourth engaging portion 24 is one said second groove. In the circumferential direction 42, the second rib has a length more than 2 times a length of the first rib, which further enhances the structural strength of the combination.

An electronic control unit 8 is disposed on the base 12, and the electronic control unit 8 is positioned to the second end portion 55 and abutted against the flange 53. The electronic control unit 8 is movable with the shaft 28 in the axial direction 41, so that the electronic control unit 8 can be individually replaced without dismantling the shell 1. The flange 53 includes a penetration hole 54 extending in the axial direction 41, and the penetration hole 54 is configured for arranged wires to electrically connect the electronic control unit 8 outside the shell 1 and the motor assembly 2 inside the shell 1. A side of the flange 53 facing toward the second through hole 121 includes a first annular member 61, and a side of the flange 53 facing toward the electronic control unit 8 includes a second annular member 62. The first annular member 61 prevents dust and/or mist form coming into the shell 1, and the second annular member 62 improves stability of the combination of the electronic control unit 8 and the shaft 28 and provides good buffering and shock-absorption.

In sum, in the design of the electric wheel hub, the maintenance and/or replacement frequency and difficulty of different components are taken into account, which allows the maintenance and/or replacement to be carried out without dismantling the motor assembly. As a result, it can greatly simplify the difficulty of maintenance and/or replacement.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric wheel hub, including:
a shell;
a motor assembly, including a stator, a rotor and a shaft, the stator and the rotor being received in the shell and relatively rotatable, the rotor being connected and rotatable with the shell, the shaft defining an axial direction and a circumferential direction, the shaft being movable in the axial direction and disposed through the stator, the shaft and the stator being relatively non-rotatable in the circumferential direction; and
a battery unit, received in the shell, electrically connected with the motor assembly.

2. The electric wheel hub of claim 1, wherein the battery unit includes a cartridge and a plurality of batteries, and the plurality of batteries are positionally received within the cartridge.

3. The electric wheel hub of claim 2, wherein inner walls of the cartridge and the shell define at least one insertion portion therebetween, and the at least one insertion portion is configured for easy detachment of the cartridge from the shell.

4. The electric wheel hub of claim 2, wherein the cartridge is disposed around the motor assembly, the cartridge is connected with the stator and is not connected with the shell, and the plurality of batteries are disposed around the motor assembly in intervals.

5. The electric wheel hub of claim 1, further including a first bearing and a second bearing, wherein the shell includes a base and a cover, the cover is detachably covered to the base, the cover includes a first through hole, the base includes a second through hole, the first bearing is received in the first through hole, the second bearing is received in the second through hole, and the shaft is disposed through the first bearing and the second bearing and protrusive out beyond opposing sides of the shell; the shaft further includes a first end portion, a connection portion, a flange and a second end portion connected in sequence; the first end portion is disposed through the first bearing and the cover, the second end portion is disposed through the second bearing and the base, the connection portion is connected with the stator, an intersection of the connection portion and the first end portion includes a stepped portion, the first bearing is abutted against the cover and the stepped portion in the axial direction, and the second bearing is abutted between the base and the flange.

6. The electric wheel hub of claim 1, wherein the shaft further includes an axle and a plurality of first engaging portions, the plurality of first engaging portions are separately arranged on the axle in the circumferential direction, the stator includes a perforation and a plurality of second engaging portions, the plurality of second engaging portions are separately arranged around the perforation in the circumferential direction, the axle is disposed through the perforation, the plurality of first engaging portions and the plurality of second engaging portions are engaged with each other, one of each said first engaging portion and each said second engaging portion is a first groove, and the other of each said first engaging portion and each said second engaging portion is a first rib.

7. The electric wheel hub of claim 6, wherein the shaft further includes a third engaging portion, the stator further includes a fourth engaging portion, the third engaging portion and the fourth engaging portion are engaged with each other, one of the third engaging portion and the fourth engaging portion is a second groove, and the other of the third engaging portion and the fourth engaging portion is a second rib; the second groove is not identical to the first groove, and the second rib is not identical to the first rib.

8. The electric wheel hub of claim 1, further including two end caps configured to be respectively connected to two fork arms, wherein the two end caps are detachably disposed respectively around opposing ends of the shaft, and the shaft is hollow and configured for a spindle to be disposed therethrough.

9. The electric wheel hub of claim 8, wherein each of the opposing ends of the shaft includes a first positioning portion, each of the two end caps includes a second positioning portion, and the second positioning portion and the first positioning portion are engaged with each other; one of the first positioning portion and the second positioning portion is a projection, and the other of the first positioning portion and the second positioning portion is a recess.

10. The electric wheel hub of claim 7, wherein the battery unit includes a cartridge and a plurality of batteries, and the plurality of batteries are positionally received within the cartridge; inner walls of the cartridge and the shell define at least one insertion portion therebetween, and the at least one insertion portion is configured for easy detachment of the cartridge from the shell; the cartridge is disposed around the motor assembly, the cartridge is connected with the stator and is not connected with the shell, and the plurality of batteries are disposed around the motor assembly in intervals; the electric wheel hub further includes a first bearing and a second bearing, the shell includes a base and a cover, the cover is detachably covered to the base, the cover includes a first through hole, the base includes a second through hole, the first bearing is received in the first through hole, the second bearing is received in the second through hole, the shaft is disposed through the first bearing and the second bearing and protrusive out beyond opposing sides of the shell; the shaft further includes a first end portion, a connection portion, a flange and a second end portion connected in sequence; the first end portion is disposed through the first bearing and the cover, the second end portion is disposed through the second bearing and the base, the connection portion is connected with the stator, an intersection of the connection portion and the first end portion includes a stepped portion, the first bearing is abutted against the cover and the stepped portion in the axial direction, and the second bearing is abutted between the base and the flange; the electric wheel hub further includes two end caps configured to be respectively connected to two fork arms, the two end caps are detachably disposed around opposing ends of the shaft, and the shaft is hollow and configured for a spindle to be disposed therethrough; each of the opposing ends of the shaft includes a first positioning portion, each of the two end caps includes a second positioning portion, and the second positioning portion and the first positioning portion are engaged with each other; one of the first positioning portion and the second positioning portion is a projection, and the other of the first positioning portion and the second positioning portion is a recess; the cartridge is made of plastic material; the cartridge is annular, the motor assembly is inserted to a central portion of the cartridge; the at least one insertion portion includes a plurality of insertion portions, and an outer circumferential wall of the cartridge includes a plurality of openings, the plurality of batteries are partially exposed from the plurality of openings; an electronic control unit is disposed on the base, and the electronic control unit is positioned to the second end portion and abutted against the flange; the flange includes a penetration hole extending in the axial direction; a side of the flange facing toward the second through hole includes a first annular member, and a side of the flange facing toward the electronic control unit includes a second annular member; each said first engaging portion is one said first rib, each said second engaging portion is one said first groove, each said third engaging portion is one said second rib, each said fourth engaging portion is one said second groove; in the circumferential direction, the second rib has a length more than 2 times a length of the first rib; the axle includes the first end portion, the connection portion, the flange and the second end portion, and the connection portion includes the plurality of first engaging portions; the stator includes a frame and a winding coil set, the winding coil set is wound around the frame, and the shaft is disposed through the frame; the frame includes the perforation, the plurality of second engaging portions and the fourth engaging portion, and the cartridge is connected with the frame.
